(19) United States
(12) Patent Application Publication
(10) Pub. No.: US 2011/0216407 A1
(43) Pub. Date: Sep. 8, 2011

(54) LIGHTING DEVICE FOR AN AUTOSTEREOSCOPIC DISPLAY

(75) Inventor: Jean-Christophe Olaya, Berlin (DE)

(73) Assignee: SeeReal Technologies S.A., Munsbach (LU)

(21) Appl. No.: 13/128,479

(22) PCT Filed: Nov. 6, 2009
(86) PCT No.: PCT/EP2009/064750

§ 371 Date: May 10, 2011

(30) Foreign Application Priority Data
Nov. 10, 2008 (DE) 10 2008 043 620.8

(51) Int. Cl. G02B 27/22

(52) U.S. Cl. 359/463

(57) ABSTRACT

The invention provides an LED light source matrix comprising light source units that have LED light sources, with the matrix, in the activated state, illuminating a subsequent microlens array with white light in collimated fashion, wherein a light source unit is associated with a plurality of microlenses that focus the light bundles and direct them through a scattering means located outside the rear focal plane of the microlens array, the scattering means having pre-defined radiating characteristics. The light bundles entering the scattering means implement extended, spatially modulated secondary light sources in order to illuminate the imaging matrix. The matrix depicts the light bundles as a range of visibility at a position determined for the eyes of observers in combination with a field lens. Areas of application include autostereoscopic displays for multiple users.

The present invention relates to a static illumination device for a transmissive autostereoscopic display. The illumination device comprises an LED light source matrix with light source units, a micro-lens array, and a diffusion means, for illuminating an imaging matrix with imaging elements which image the pencils of light to a visibility region at a detected position of observer eyes. After modulation of the light with image information and other information in the image display panel, observer eyes can see a selected stereoscopic and/or monoscopic presentation from this visibility region.

The field of application of the present invention includes autostereoscopic displays where dedicated visibility regions are generated for the eyes of different observers, and where the positions of the observer eyes are detected with the help of a position finder. The visibility regions can be tracked to the observers automatically if they move to a different position in a relatively large viewing space in front of the display device. Stereo images and/or other information are represented to the observers either in a 2D mode or in a 3D mode or as a simultaneous presentation of 2D and 3D contents in the display device in synchronism with the generation of the visibility regions.

A number of solutions have been proposed in the prior art to illuminate autostereoscopic displays. It is known to use a directional illumination unit in an autostereoscopic display in order to follow position changes of observers and to generate visibility regions at the new positions. For this, an illumination means with a multitude of light-emitting or light-transmitting illumination elements is combined with an imaging means with imaging elements. The number and location of the illumination elements which are to be activated are determined depending on the actual observer position. The imaging elements image the light of the activated illumination elements through the display panel to a visibility region with a detected left or right observer eye in the viewing space. An image controller provides the corresponding left or right stereo image to the display panel in synchronism with that.

Great demands are made on an illumination device in an autostereoscopic display for presenting three-dimensional scenes to multiple observers. A disadvantage of most illumination devices is the cross-talking of the left stereo image to the right eye and vice versa, so that an incorrect 3D presentation is perceived. Further problems are brought about by aberrations caused by the non-axial tracking of the visibility regions, where said aberrations confine the viewing space which can effectively be addressed by the illumination device. Autostereoscopic displays for multiple observers are typically optimised for one observer. If multiple observers want to see the displayed 3D scene at the same time, they often have to cope with disadvantages.

The display panel, which is preferably a commercially available LC display panel, and the visibility region shall be illuminated as bright and homogeneous as possible. The use of an LC panel, also referred to as shutter panel, for illuminating the display panel always requires a backlight. The light sources which are used for this emit heat when in use, which can have more or less grave adverse effects on the function of the components of the display device. The shutter elements, which are arranged in a matrix, have division bars between neighbouring elements to accommodate the electric signal lines. If the illuminated elements are imaged by lenticulars, the margins of the lenticules receive less light, so that they appear on the image matrix as thin, darkish longitudinal stripes, because the division bars emit less light than the illuminated elements. This impairs the overall sensation of the 3D presentation. A normal optical diffusion means does not fully eliminate this defect. Another problem is the low efficiency of the illumination means used. On its way from the illumination means to the display panel and to the observer eye, too much light is lost e.g. by absorption or reflection. The transmittance is often greatly reduced.

It is the object of the invention to improve the illumination device for an autostereoscopic display where multiple observers can watch the 3D presentation with dedicated visibility regions. The illumination device shall have a high luminous efficiency. This means that with little effort as regards the light source means a great luminous intensity shall be achieved both in the display panel and in the individual visibility regions which are generated for each observer. The 3D presentation shall be free from aberrations as far as possible for observer positions within a large angular range in front of the display device. Further above-mentioned disadvantages of the prior art shall be eliminated as far as possible at the same time.

The present invention is based on an illumination device which involves a combination of a backlight device, a micro-lens array and a diffusion means. The backlight device comprises an LED light source matrix with light source units. According to the characterising features of this invention, the light source units comprise LED light sources which if activated illuminate the micro-lens array which is disposed downstream in a collimated manner with white light, where one light source unit is assigned to multiple micro-lenses which focus the pencils of light and transmit them through the diffusion means which is disposed outside the focal plane of the micro-lens array and which has a defined emission characteristic, whereby the pencils of light which hit the diffusion means realise large spatially modulated secondary light sources for illuminating the imaging matrix.

In an embodiment of the present invention the emission characteristic of the diffusion means is computed depending on the size of the surface of an imaging element to be illuminated so that light is transmitted exactly through this surface of the imaging element. A further parameter of the computation can be the distance of the diffusion means to a visibility region or to the observer eyes so to precisely determine the imaging element which is to be illuminated.

The diffusion means preferably carries the computed emission characteristic in the form of a holographic structure. With this the extension of the secondary light sources which are to be generated can be defined.

In a further embodiment of the illumination device, the diffusion means has greyscale steps in order to realise an amplitude modulation. With this the spatial extent of the secondary light sources which are to be generated can be controlled.

Further, it is provided according to this invention that one light source unit realises multiple secondary light sources for illuminating an imaging element.

The pencils of light emitted by the secondary light sources which are generated by the diffusion means can additionally be confined to one imaging element each by confining means which are disposed between the diffusion means and the imaging matrix. This serves to make sure that cross-talking between the pencils of light of neighbouring imaging elements does not occur. The confining means are for example arranged in columns. These means can be omitted if the imaging matrix is directly attached to the diffusion means. The imaging elements of the imaging matrix are preferably the lenticules of a lenticular.

The object is further solved by an autostereoscopic display which comprises an illumination device which includes at least one of the above-mentioned inventive features. A preferred embodiment comprises a Fresnel lens with controllable zones as a field lens.

The invention further comprises a method for generating an illumination for an autostereoscopic display where the illumination device comprises an LED light source matrix with light source units, a micro-lens array with micro-lenses and a diffusion means for illuminating an imaging matrix with imaging elements which in combination with a field lens image all pencils of light to a visibility region at a detected position of observer eyes. According to this invention, the method is realised in that the light source units comprise LED light sources which generate collimated pencils of light of white light, where one light source unit is assigned to multiple micro-lenses of the micro-lens array which is disposed downstream where the micro-lenses focus the collimated pencils of light through the diffusion means which is situated downstream in the optical path outside the rear focal plane of the micro-lens array and which comprises a defined emission characteristic, whereby the pencils of light which hit the diffusion means realise large spatially modulated secondary light sources for illuminating the imaging matrix.

This invention provides a static illumination device which generates an efficient illumination for the autostereoscopic display device. The individual embodiments of this invention provide further advantages: The use of LED light sources a priori allows a higher efficiency of the luminous intensity in an autostereoscopic display, although the number of light sources is lower than that in an arrangement with an LCD shutter panel. The planar light source units, which are seamlessly adjoined both in the horizontal and in the vertical direction, form a homogeneous light-emitting surface. This light-emitting surface serves as a basis for generating secondary light sources, which can the efficiency of the illumination further increase by additionally given specific measures.

Cross-talking is minimised by a combination of different measures: Illuminating the micro-lens array with collimated light prevents cross-talking from occurring already at that stage. Cross-talking is further prevented in that the secondary light sources of the diffusion means generate precisely defined illumination cones for an imaging element which follows in the optical path. Attaching a lenticular which serves as an imaging matrix directly onto the diffusion means also contributes to circumvent cross-talking.

Generating spatially modulated secondary non-point light sources in the diffusion means which is disposed out of focus realises a large areal illumination of the image display panel and of the visibility regions to be generated in the viewing space. A modulation of the optical transmittance of the diffusion means makes it possible to control the shape of the visibility regions. At the same time, it is possible to vary the size of the visibility regions for observer eyes. The extension of the secondary light sources is chosen such that the light slightly diverges after the transmission though the imaging matrix, which is preferably a lenticular. Thereby the visibility region can be enlarged somewhat in the horizontal direction. Altogether, the luminous efficiency can almost be as high as 80% in an autostereoscopic display with this invention.

The use of the illumination device is particularly preferred when the lenticular is followed by a controllable field lens which is based on the principle of an electrowetting cell. This can for example be a Fresnel lens. The Fresnel lens has controllable zones in which prisms are generated which give the pencils of light a definable deflection towards detected observer eyes. The prisms can be controlled such that aberrations in the beam path are avoided. Adjustments of the beam path which is caused by flaws in the material or mismatch of the components of the autostereoscopic display during assembly can also be performed with the help of the controllable zones.

The present invention will be described in detail below with the help of embodiments, and accompanying drawings, which are all schematic top views, where:

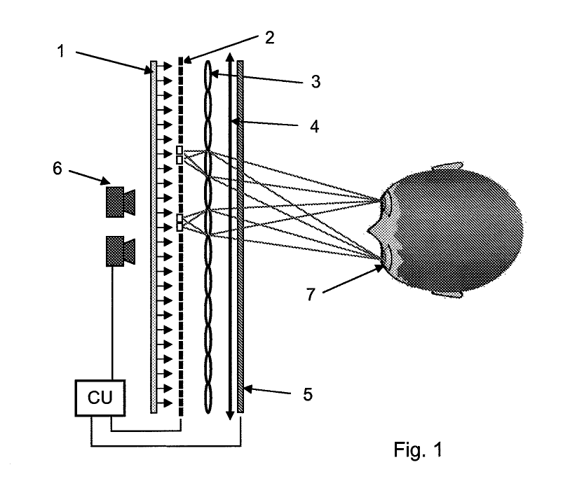

FIG. 1 shows an autostereoscopic display with directional illumination unit according to the prior art,

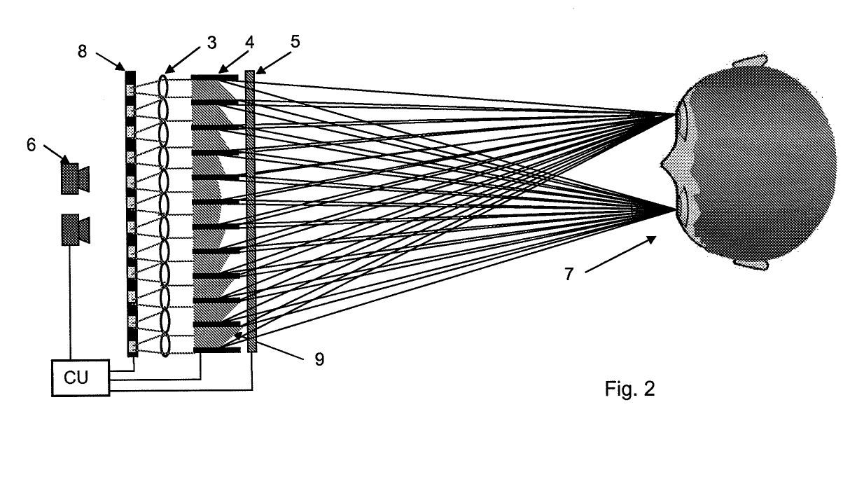

FIG. 2 shows an autostereoscopic display with illumination device according to this invention, and

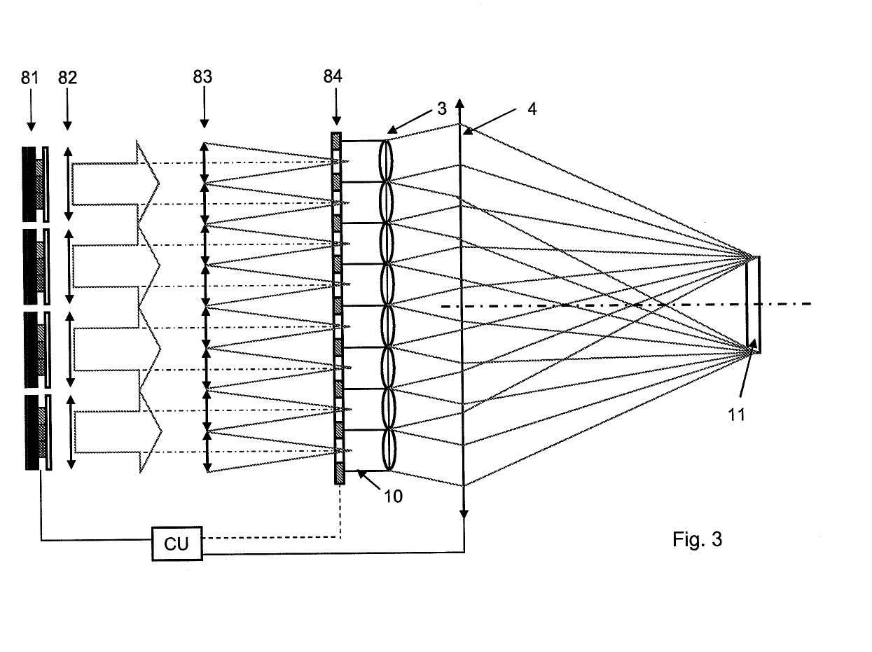

FIG. 3 shows for an autostereoscopic display according to FIG. 2 the individual components of the illumination device according to this invention and the beam path through the entire display device.

Like numerals denote like components in the individual Figures.

FIG. 1 shows an autostereoscopic display with directional illumination unit according to the prior art. A position finder 6 is followed in the direction of light propagation by a backlight, which comprises light source means 1, and an LC panel which serves as a shutter 2 with controllable openings. Openings which are switched to a transmissive mode are sequentially imaged by an imaging matrix 3 through a field lens 4 and an image display panel 5 to the left and right eye 7 of an observer. A lenticular is provided as imaging matrix 3. The control means CU receive the position information of the observer eyes 7 from the position finder 6. Further, the control means CU are connected with the backlight and with the image display panel 5 in order to control the illumination and the image display for the observer eyes 7. Different openings of the shutter panel 2 are switched column-wise to a transmissive mode by the control means CU depending on the detected observer position (direction) within a space in front of the image display panel 5.

FIG. 2 shows an autostereoscopic display with the static illumination device 8 according to this invention, which follows the position finder 6 in the direction of light propagation. In analogy with FIG. 1, the light of the static illumination device 8 is sequentially imaged by the imaging matrix 3 through a field lens 4 and an image display panel 5 to the left and right eye 7 of an observer. Where multiple observers are served, the respective contents can be imaged onto the individual eyes sequentially or simultaneously. A lenticular is provided as imaging matrix 3. The position finder 6, the field lens 4 and the image display panel 5 are connected with the control means CU which controls the illumination and the image display for the observer eyes 7.

FIGS. 1 and 2 are substantially different with respect to the design of the optical components of the illumination device 8 and field lens 4. The field lens 4 is a Fresnel lens with controllable or switchable zones 9 which generate prisms for deflecting pencils of light. The prism angle of the prisms can be set variably depending on the detected position of the observer eyes 7.

FIG. 3 shows a more detailed view of the static illumination device 8 and the path of the pencils of light through the autostereoscopic display. The illumination device 8 comprises an LED light source matrix 81 with a number of light source units, a micro-lens array 83 with micro-lenses, and a diffusion means 84. A light source unit comprises three LED light sources in the colours red, green and blue and a lens 82 on its front surface. The light source units are arranged next to each other in rows and columns and generate a continuously luminous two-dimensional surface of collimated white light when they are activated. The lenses 82 have such an optic- geometric design that they guide the two-dimensional surface of white light in a collimated manner onto the micro-lens array 83. The arrows which originate in the lenses 82 represent the collimated pencils of light. As is commonly known, a light source unit which shall emit white light can also comprise a conjunction of blue LEDs with a phosphorescent system.

The micro-lenses of the micro-lens array 83 focus the pencils of light onto the rear focal plane. The diffusion means 84 is arranged there near that focal plane. This serves to achieve that the pencils of light generate spatially modulated secondary, non-point light sources in the diffusion means 84. These secondary light sources provide a large areal illumination for the display device and for the visibility regions which are to be generated in the viewing space. In this embodiment, two micro-lenses are assigned column-wise to one lens 82. The LED light source units can also be designed such that they illuminate more than two micro-lenses. Both the lenses 82 of the LED light source units and the micro-lenses of the micro-lens array 83 are only represented by double arrows in this drawing. A double arrow roughly corresponds with the lens diameter. As the pencils of light are focussed, illumination cones are created which run from the tips of the double arrows to the respective rear focal planes of the micro-lenses. The diffusion means 84, which exhibits a special emission characteristic, is disposed upstream of the focal planes and transmitted by the illumination cones. Thereby, in the diffusion means 84 multiple secondary light sources are generated from the pencils of light of one light source unit. They again form illumination cones each of which specifically illuminate column-wise about one lenticule of the lenticular.

To make sure that only the intended illumination cone illuminates the assigned lenticule, confining means 10 can additionally be disposed in parallel arrangement between the diffusion means 84 and the lenticular. They can have a columnar shape and serve to prevent cross-talking. They shall be preferably light-absorbing. However, the confining means 10 can be omitted if the lenticular is attached directly onto the diffusion means 84.

The pencils of light which are emitted by the lenticular in a slight divergent manner are superposed by the field lens 4, which is disposed further downstream in the form of a controllable Fresnel lens, into a visibility region 11 of an observer eye. An observer eye (not shown) can see image information which is synchronously provided by the control means CU from that visibility region. The image information is perceived three-dimensional if a left and a right stereo image are sequentially provided to the respective observer eye in the respective visibility regions at a fast pace. The image display panel 5 is not shown in FIG. 3.

The basis for generating the desired secondary light sources is a diffusion means 84 with a defined emission characteristic. The emission characteristic or the angle of radiation is matched with the imaging elements, e.g. the width of the lenticules of the lenticular and to the distance between the diffusion means 84 and the lenticule. The angle of radiation is realised only as large as necessary for one emitted pencil of light to pass two-dimensionally through the one subsequent lenticule only. This aims to prevent light loss and to suppress cross-talking. By using a diffusion means 84 which is made holographically the emission characteristic can be defined a priori. It can be firmly stored if it is a holographic structure in the diffusion means 84.

The illumination cones which are realised by the secondary light sources generate a visibility region 11 of a defined size. The size can be defined such that it covers one eye or simultaneously both eyes of an observer. If it covers both eyes, the display works in the 2D mode. The size of the visibility region 11 and the extension of the secondary light sources are proportionate to each other according to the laws of ray optics.

To realise an amplitude modulation, the diffusion means 84 can additionally have greyscale steps in order to define a desired extension of the generated secondary light sources. The extension is the same for all secondary light sources. This way the shape and size of the visibility region can be controlled.

The optic-geometric form of the surfaces of the lenses 82 of the light source units can be spherical or aspherical.

1. Illumination device for an autostereoscopic display, comprising a LED light source matrix with light source units, a micro-lens array with micro-lenses, and a scattering means, where an imaging matrix with imaging elements is illuminated which in combination with a field lens image the pencils of light to a visibility region at a detected position of observer eyes,
wherein the light source units comprise LED light sources which are to be actuated to illuminate the micro-lens array which is disposed downstream in a collimated manner with white light, where one light source unit is assigned to multiple micro-lenses which focus the pencils of light and transmit them through the scattering means which is disposed outside a rear focal plane of the micro-lens array and which has a defined emission characteristic, whereby the pencils of light which hit the scattering means realise large spatially modulated secondary light sources for illuminating the imaging matrix.

2. Illumination device according to claim 1, wherein the emission characteristic of the scattering means is to be computed depending on a size of a surface of an imaging element to be illuminated so that light is transmitted exactly through this surface of the imaging element.

3. Illumination device according to claim 2, wherein the scattering means comprises the computed emission characteristic in the form of a holographic structure.

4. Illumination device according to claim 1, wherein the scattering means additionally has greyscale steps for realizing an amplitude modulation in order to control the a spatial extent of secondary light sources to be generated.

5. Illumination device according to claim 1, wherein one light source unit realises multiple secondary light sources for illuminating an imaging element.

6. Illumination device according to claim 1, wherein the imaging matrix is directly attached to the scattering means.

7. Illumination device according to claim 6, wherein the imaging matrix is a lenticular.

8. Illumination device according to claim 1, wherein confining means are additionally disposed between the scattering means and the imaging matrix in order to confine the pencils of light to a related imaging element.

9. Autostereoscopic display comprising an illumination device according to at least one of claims 1 to 8.

10. (canceled)

11. Method for generating an illumination for an autostereoscopic display, where the an illumination device comprises a LED light source matrix with light source units, a micro-lens array with micro-lenses, and a scattering means, for illuminating an imaging matrix with imaging elements which in combination with a field lens image pencils of Bays light to a visibility region at a detected position of observer eyes, wherein the light source units comprise LED light sources which are to be activated to illuminate the micro-lens array which is disposed downstream in a collimated manner with white light, where one light source unit is assigned to multiple micro-lenses which focus the pencils of light and transmit them to the scattering means which is disposed outside a rear focal plane of the micro-lens array and which has a defined emission characteristic, with which large spatially modulated secondary light sources for illuminating the imaging matrix are to realise.
